(19) United States
(12) Patent Application Publication
(10) Pub. No.: US 2005/0063252 A1
(43) Pub. Date: Mar. 24, 2005

(54) Method for the detection of damage to spacecraft caused by the impact of foreign bodies

(76) Inventor: Wolfgang Wulfken, Stuhr (DE)

Correspondence Address: FASSE PATENT ATTORNEYS, P.A., P.O. BOX 726, HAMPDEN, ME, 04444-0726, US

(21) Appl. No.: 10/497,880

(22) PCT Filed: Feb. 15, 2003
(86) PCT No.: PCT/DE03/00462

(30) Foreign Application Priority Data
Feb. 28, 2002 (DE) 102 08 724.5

(51) Int. Cl. G01S 5/22

(52) U.S. Cl. 367/124

(57) ABSTRACT

In a method for the detection of damages to spacecraft caused by the impact of foreign bodies, the ultrasound vibrations caused by an impact are electronically registered and provided to an evaluating unit for the mathematical localization of the location of the damage, whereby the registering and evaluating process is automatically triggered, and known ultrasound vibrations caused by foreign systems are screened out. An apparatus for the carrying out of this method consists of at least three ultrasound sensors arranged spatially on the surface of the body that is to be monitored, as well as an electronic detection and evaluating unit allocated thereto.

The invention relates to a method for the detection of damages to spacecraft caused by the impact of foreign bodies by means of sound measurement. Further, it relates to an apparatus for the carrying out of such a method.

Onboard spacecraft, strikes of meteorites and debris parts generally lead to damages of the structure. Especially, they can lead to holes in the outer hull, which represent a considerable danger for the crew of the affected craft, because the interior pressure diminishes and therewith the breathable oxygen is lost. The systems and methods previously used onboard spacecraft for the detection of such damages, which are based on a measurement of the audible sound, are, however, not in a position to locate and indicate the exact location of the strike of such a foreign body.

According to the JP 04-297400 A, a vibration measuring method for the detection of damages/strikes of foreign bodies in connection with spacecraft has become known, whereby the vibrations are electronically registered and the impact is determined mathematically via an evaluating unit. No indications are known, however, regarding what vibrations are implicated, and how a measuring method can be carried out.

Indeed, it has been generally shown, according to the DE 30 33 990 C2, a method for the location and analysis of (ultra) sound emissions, generated by crack formation in the microrange for example, for the early recognition of damage locations in apparatuses and components. In that context, no working use is made of an active excitation, but rather, the arising ultrasound signals are purely passively detected and processed.

It is an object of the invention to develop a method of the above mentioned type in such a manner so that it makes possible the exact ascertaining of the impact location of meteorites and debris parts, and thus an immediate danger recognition. A further object of the invention is to provide an apparatus for the carrying out of such a method.

The invention achieves the first object through a method in which the ultrasound vibrations caused by an impact are electronically registered and provided to an evaluating unit for the mathematical localization of the location of the damage. The further object is achieved with an apparatus according to the patent Claim 4.

In that regard, the invention uses the physical effect, that already the smallest openings in the outer skin of a spacecraft generate ultrasound vibrations due to the gas flowing out therethrough, which ultrasound vibrations are suitable for the detection and localization of the damage location. Since the method according to the invention in an advantageous further embodiment is first activated by the impact of a foreign body, it can remain in a resting or waiting condition during the predominant part of a space flight mission, and thereby requires only very little electrical energy. Moreover, the inventive method makes it possible that also damages or impacts, which do not lead to holes in the outer skin of the spacecraft, which, however, represent potential danger sources, are similarly detected.

Indeed it is already known by itself as such from the field of non-destructive material testing, to carry out material tests by means of ultrasound vibrations in such a manner so that ultrasound vibrations of certain determined frequencies are introduced into the material or workpiece that is to be tested, and that texture changes in the material, which have been caused by damages and which lead to reflections, mode conversion, diffraction and weakening of the ultrasound waves, are used for the identification of the defects or faults. This technology, however, is based on an active excitation of the workpieces to be tested, and is not suitable for an application in the space flight technology.

Through full utilization of the physical effect, of transversal and longitudinal waves that progressively spread out with a running or transit time difference of about 50% in the solid medium, and which arise at the location of the damage, it is possible to carry out a location of the strike locations with the aid of the triangulation method.

In the following, the invention shall be explained in greater detail in connection with an example embodiment illustrated in the drawing. It is shown by:

FIG. 1 an arrangement for the detection of damages by means of ultrasound sensors;

FIG. 2 a principle illustration of an evaluating unit for an arrangement according to FIG. 1; and

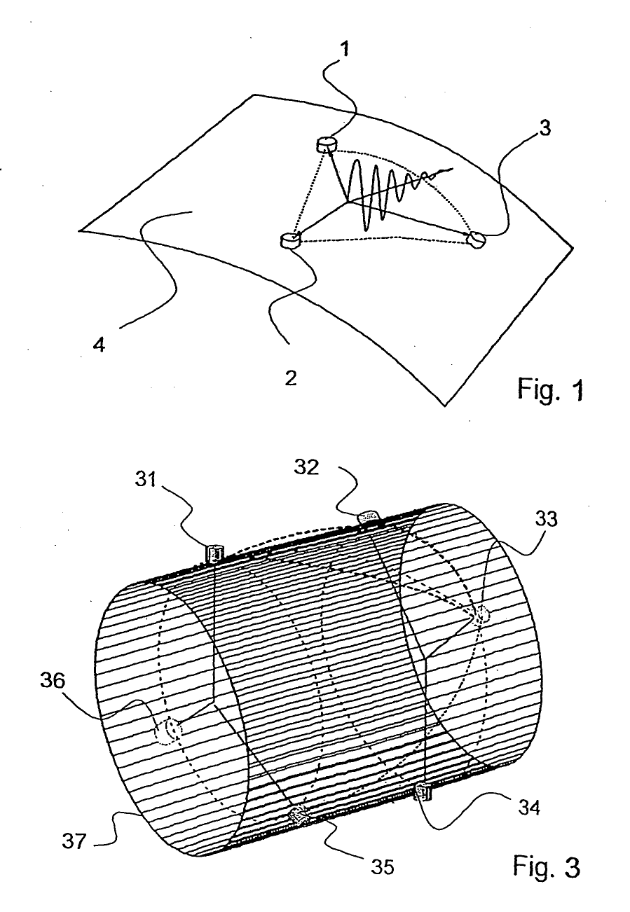

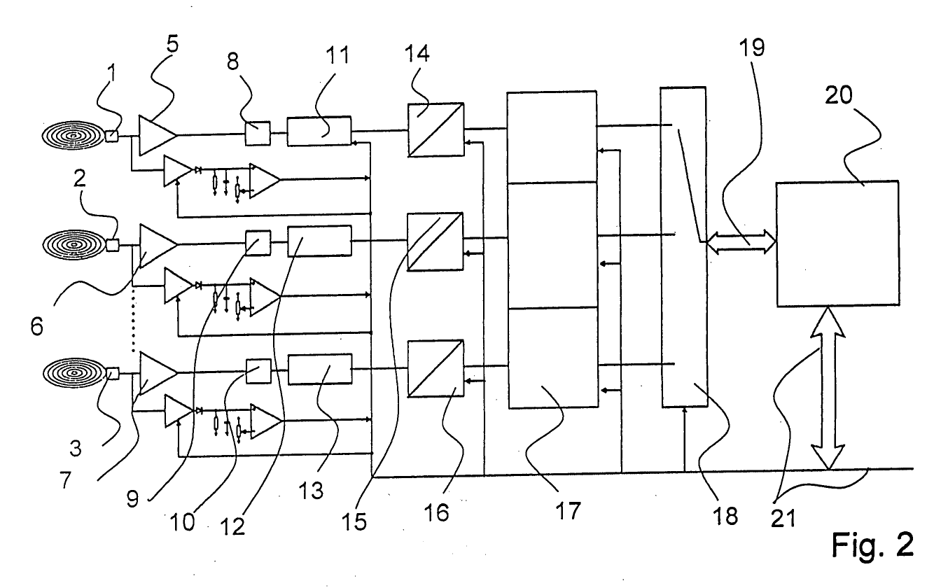

FIG. 3 a module of a space station with an arrangement according to the FIGS. 1 and 2.

The illustration in FIG. 1 shows a measuring system that carries out a location of ultrasound sources via a triangular running or transit time and phase measurement of ultrasound waves with the use of mathematical correlation processes, and thus makes possible a localization of an impact or damage location. The detection of the vibration in the beginning condition takes place with the aid of at least three ultrasound sensors 1, 2 and 3, which record independently of one another, and which are synchronously operating, and which, in the arrangement illustrated according to FIG. 1 in the drawing, are arranged in an equiangular equilateral triangle on a surface 4 that is to be monitored. In that regard it is to be noted that this arrangement in an equiangular equilateral triangle, while preferred, is not absolutely necessary for the carrying out of the method described here. Each of the sensors 1 to 3 is connected with an allocated or associated measuring and memory electronics, which transfers the measured data to a process computer for evaluation, as this is illustrated in detail in FIG. 2.

FIG. 2 shows, that each ultrasound sensor 1 to 3 is connected with an allocated or associated amplifier 5 to 7 connected after or downstream thereof, whereby these amplifiers 5 to 7 in turn act via filters 8 to 10 on sample-and-hold stages 11 to 13. The latter respectively have an A/D converter 14 to 16 connected thereafter or downstream thereof, which on their part are connected with a memory unit 17. The areas of this memory unit 17 allocated to the individual sensors 1 to 3 are connected via a multiplexer 18 and a databus 19 with the process computer 20. This in turn acts on the individual above described components via a control bus 21 with corresponding address lines.

Transient ultrasound waves arise directly after an impact of meteorites and debris parts, and are used in the above described arrangement, on the one hand to activate the detection system, and on the other hand to measure the wave transit time. In that regard, the ultrasound sensor located closest to a strike location, the sensor 1 in the case of the example shown in FIG. 1, detects the incident ultrasound wave as the first measuring transducer or pick-up and triggers the measuring system. The remaining sensors 2 and 3 pick-up or record the ultrasound signal after a corresponding delay time corresponding to their spacing distance to the impact location. The arising phase and amplitude differences are used in the evaluating unit for the determination of the strike position. The evaluation of ultrasound vibrations in the stationary condition takes place under full utilization of the damping effect of the ultrasound waves, which can be caused by the material characteristics and can be detected by means of a phase comparison to be carried out by the above described sensor and measuring arrangement. In that regard, the process computer is programmed in such a manner, so that known ultrasound vibrations caused by foreign systems are screened out.

FIG. 3 finally shows an arrangement corresponding to that described above, in which the sensors 31 to 36 are arranged distributed on the surface of a space station 37, in order to effectuate the monitoring function that is to be achieved.

1. Method for the detection of damages to spacecraft caused by the impact of foreign bodies by means of sound measurement, characterized in that the ultrasound vibrations caused by an impact are electronically registered and provided to an evaluating unit for the mathematical localization of the location of the damage.

2. Method according to claim 1, characterized in that an automatic triggering of the registering and evaluating process takes place.

3-4 (canceled).

5. Method according to claim 1, characterized in that known ultrasound vibrations caused by foreign systems are screened out.

6. Apparatus for the carrying out of the method according to claim 1, consisting of at least three ultrasound sensors (1-3, 31-36) arranged spatially on the surface (4, 37) of the body that is to be monitored, as well as a detection and evaluating unit (5-21) allocated thereto.
